(19) United States
(12) Patent Application Publication
(10) Pub. No.: US 2026/0264320 A1
(43) Pub. Date: Sep. 10, 2026

(54) THREE-DIMENSIONAL SHAPED OBJECT MANUFACTURING METHOD

(71) Applicant: SEIKO EPSON CORPORATION, Tokyo (JP)

(72) Inventor: Satoshi YAMAZAKI, MATSUMOTO-SHI (JP)

(73) Assignee: SEIKO EPSON CORPORATION, Tokyo (JP)

(21) Appl. No.: 19/560,192

(22) Filed: Mar. 9, 2026

(30) Foreign Application Priority Data
Mar. 10, 2025 (JP) 2025-037188

(51) Int. Cl. B29C 64/118; B29C 64/209; B33Y 10/00; B33Y 30/00

(52) U.S. Cl. CPC B29C 64/118; B29C 64/209; B33Y 10/00; B33Y 30/00

(57) ABSTRACT

A three-dimensional shaped object manufacturing method includes a plasticizing step and an ejecting step of ejecting a plasticized material from a first nozzle and a second nozzle disposed side by side in a first axial direction toward a stage. The ejecting step includes ejecting the plasticized material from the first nozzle, raising the first nozzle in a second axial direction perpendicular to the stage and lowering the second nozzle in the second axial direction, and ejecting the plasticized material from the second nozzle after the nozzle switching step. The nozzle switching step is performed at a position where height in the second axial direction of a distal end of the first nozzle and height in the second axial direction of a distal end of the second nozzle are higher than height in the second axial direction of a shaped object including the shaping layer.

The present application is based on, and claims priority from JP Application Serial Number 2025-037188, filed Mar. 10, 2025, the disclosure of which is hereby incorporated by reference herein in its entirety.

### BACKGROUND

### 1. Technical Field

The present disclosure relates to a three-dimensional shaped object manufacturing method.

### 2. Related Art

There is a known method of manufacturing a three-dimensional shaped object by ejecting a plasticized material from nozzles toward a stage and curing the material.

For example, JP-A-2024-51362 describes a three-dimensional shaping apparatus including two nozzles.

In the three-dimensional shaping apparatus described above, when a plasticized material is ejected from a first nozzle of the two nozzles, the first nozzle is brought close to a stage to eject the plasticized material and form a shaping layer on the stage. Subsequently, when the plasticized material is ejected from a second nozzle, the first nozzle is brought away from the stage and the second nozzle is brought close to the stage to eject the plasticized material.

JP-A-2024-51362 is an example of the related art.

However, in the three-dimensional shaping apparatus explained above, when the second nozzle is brought close to the stage, the second nozzle comes into contact with the shaping layer formed on the stage and shaping failure is likely to occur.

### SUMMARY

According to an aspect of the present disclosure, there is provided a three-dimensional shaped object manufacturing method for manufacturing a three-dimensional shaped object by ejecting a plasticized material from a first nozzle and a second nozzle disposed side by side in a first axial direction toward a stage and stacking a shaping layer formed by the plasticized material on the stage, the three-dimensional shaped object manufacturing method including: a plasticizing step of plasticizing a material to generate the plasticized material; and an ejecting step of ejecting the plasticized material from the first nozzle and the second nozzle toward the stage while moving the first nozzle and the second nozzle relatively to the stage in the first axial direction, wherein the ejecting step includes: a first ejecting step of ejecting the plasticized material from the first nozzle; a nozzle switching step of raising the first nozzle in a second axial direction perpendicular to the stage and lowering the second nozzle in the second axial direction after the first ejecting step; and a second ejecting step of ejecting the plasticized material from the second nozzle after the nozzle switching step, and the nozzle switching step is performed at a position where height in the second axial direction of a distal end of the first nozzle and height in the second axial direction of a distal end of the second nozzle are higher than height in the second axial direction of a shaped object including the shaping layer.

### BRIEF DESCRIPTION OF THE DRAWINGS

FIG. 1 is a perspective view schematically illustrating a three-dimensional shaping apparatus according to an embodiment.

FIG. 2 is a cross-sectional view schematically illustrating the three-dimensional shaping apparatus according to the embodiment.

FIG. 3 is a perspective view schematically illustrating a flat screw of the three-dimensional shaping apparatus according to the embodiment.

FIG. 4 is a plan view schematically illustrating a barrel of the three-dimensional shaping apparatus according to the embodiment.

FIG. 5 is a flowchart illustrating processing of a control unit of the three-dimensional shaping apparatus according to the embodiment.

FIG. 6 is a cross-sectional view illustrating shaping layer forming processing by the control unit of the three-dimensional shaping apparatus according to the embodiment.

FIG. 7 is a flowchart illustrating the shaping layer forming processing by the control unit of the three-dimensional shaping apparatus according to the embodiment.

FIG. 8 is a cross-sectional view illustrating the shaping layer forming processing by the control unit of the three-dimensional shaping apparatus according to the embodiment.

FIG. 9 is a cross-sectional view illustrating the shaping layer forming processing by the control unit of the three-dimensional shaping apparatus according to the embodiment.

FIG. 10 is a cross-sectional view illustrating the shaping layer forming processing by the control unit of the three-dimensional shaping apparatus according to the embodiment.

FIG. 11 is a cross-sectional view illustrating the shaping layer forming processing by the control unit of the three-dimensional shaping apparatus according to the embodiment.

FIG. 12 is a cross-sectional view illustrating the shaping layer forming processing by the control unit of the three-dimensional shaping apparatus according to the embodiment.

FIG. 13 is a cross-sectional view illustrating the shaping layer forming processing by the control unit of the three-dimensional shaping apparatus according to the embodiment.

FIG. 14 is a cross-sectional view illustrating the shaping layer forming processing by the control unit of the three-dimensional shaping apparatus according to the embodiment.

FIG. 15 is a cross-sectional view illustrating the shaping layer forming processing by the control unit of the three-dimensional shaping apparatus according to the embodiment.

FIG. 16 is a flowchart illustrating a first modification of the shaping layer forming processing by the control unit of the three-dimensional shaping apparatus according to the embodiment.

FIG. 17 is a cross-sectional view illustrating the first modification of the shaping layer forming processing by the control unit of the three-dimensional shaping apparatus according to the embodiment.

FIG. 18 is a cross-sectional view illustrating the first modification of the shaping layer forming processing by the control unit of the three-dimensional shaping apparatus according to the embodiment.

FIG. 19 is a flowchart illustrating a second modification of the shaping layer forming processing by the control unit of the three-dimensional shaping apparatus according to the embodiment.

FIG. 20 is a cross-sectional view illustrating the second modification of the shaping layer forming processing by the control unit of the three-dimensional shaping apparatus according to the embodiment.

FIG. 21 is a cross-sectional view illustrating the second modification of the shaping layer forming processing by the control unit of the three-dimensional shaping apparatus according to the embodiment.

FIG. 22 is a flowchart illustrating a third modification of the shaping layer forming processing by the control unit of the three-dimensional shaping apparatus according to the embodiment.

FIG. 23 is a cross-sectional view illustrating the third modification of the shaping layer forming processing by the control unit of the three-dimensional shaping apparatus according to the embodiment.

FIG. 24 is a cross-sectional view illustrating the third modification of the shaping layer forming processing by the control unit of the three-dimensional shaping apparatus according to the embodiment.

### DESCRIPTION OF EMBODIMENTS

A preferred embodiment of the present disclosure is explained below in detail with reference to the drawings. The embodiment explained below does not unduly limit the content of the present disclosure described in the claims. In addition, not all of components explained below are always essential elements of the present disclosure.

### 1. Three-dimensional shaping apparatus

### 1.1. Overall configuration

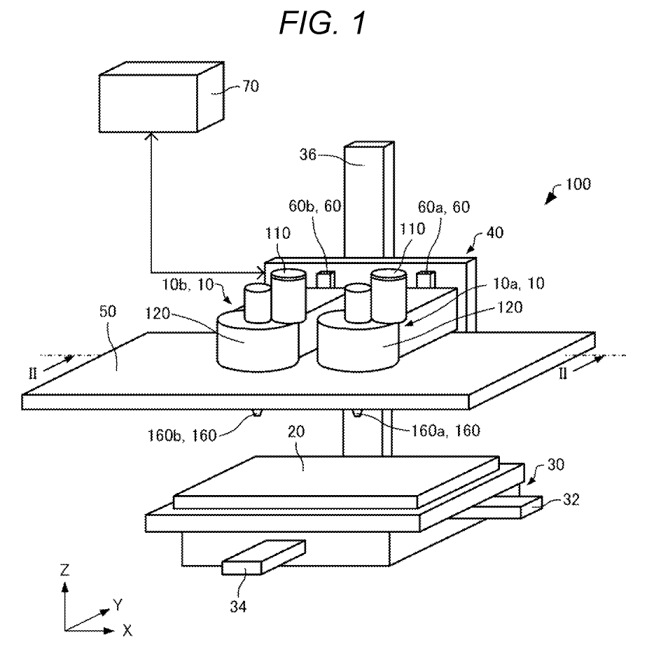

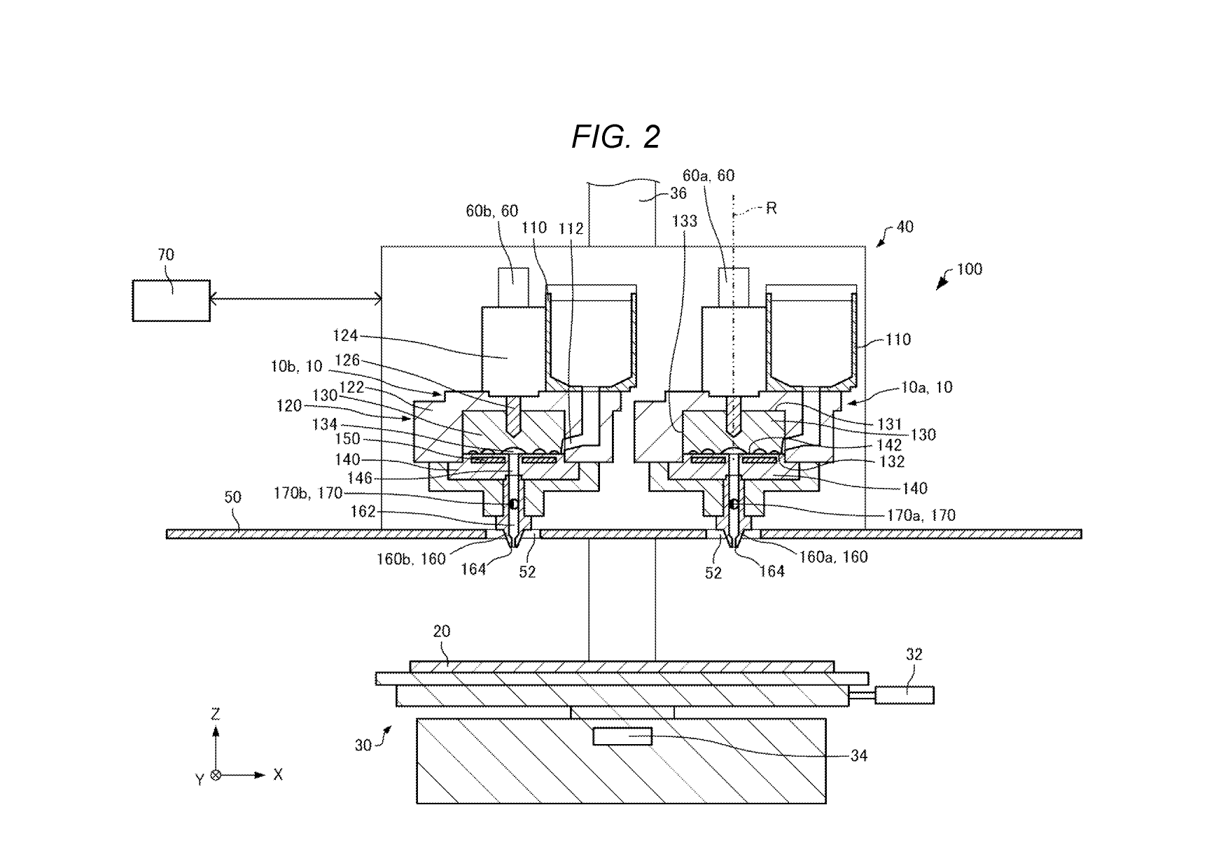

First, a three-dimensional shaping apparatus according to the present embodiment is explained with reference to the drawings. FIG. 1 is a perspective view schematically illustrating a three-dimensional shaping apparatus 100 according to the present embodiment. FIG. 2 is a cross-sectional view taken along a line II-II in FIG. 1 schematically illustrating the three-dimensional shaping apparatus 100 according to the embodiment. In FIGS. 1 and 2, an X-axis, a Y-axis, and a Z-axis are illustrated as three axes orthogonal to one another. An X-axis direction and a Y-axis direction are, for example, the horizontal direction. A Z-axis direction is, for example, the vertical direction.

As illustrated in FIGS. 1 and 2, the three-dimensional shaping apparatus 100 includes, for example, an ejection unit 10, a stage 20, a position changing unit 30, a support unit 40, a heating plate 50, a drive unit 60, and a control unit 70.

While causing the ejection unit 10 to eject a plasticized material toward the stage 20, the three-dimensional shaping apparatus 100 drives the position changing unit 30 to change relative positions of the ejection unit 10 and the stage 20. Accordingly, the three-dimensional shaping apparatus 100 stacks, on the stage 20, a shaping layer formed by the plasticized material and manufactures a three-dimensional shaped object. The three-dimensional shaping apparatus 100 is a three-dimensional shaping apparatus of a fused deposition modeling (FDM) type.

The three-dimensional shaping apparatus 100 includes a first ejection unit 10a and a second ejection unit 10b as the ejection units 10. In an illustrated example, the first ejection unit 10a and the second ejection unit 10b are disposed side by side in the X-axis direction. Configurations of the first ejection unit 10a and the second ejection unit 10b are, for example, the same. Both of the first ejection unit 10a and the second ejection unit 10b may eject the plasticized material forming the three-dimensional shaped object or one of the first ejection unit 10a and the second ejection unit 10b may eject the plasticized material forming the three-dimensional shaped object and the other may eject the plasticized material forming a support material that supports the three-dimensional shaped object. For example, the first ejection unit 10a may eject the plasticized material forming the three-dimensional shaped object and the second ejection unit 10b may eject the plasticized material forming the support material.

The ejection unit 10 includes, as illustrated in FIG. 2, for example, a material supply unit 110, a plasticizing unit 120, a nozzle 160, and a valve 170.

The material supply unit 110 stores a pellet-like or powder-like material. The material supply unit 110 supplies the material to the plasticizing unit 120. The material supply unit 110 includes, for example, a hopper. The material supplied by the material supply unit 110 is, for example, acrylonitrile butadiene styrene (ABS) resin.

The material supply unit 110 and the plasticizing unit 120 are coupled by a supply path 112 provided below the material supply unit 110. The material put in the material supply unit 110 is supplied to the plasticizing unit 120 via the supply path 112.

The plasticizing unit 120 includes, for example, a screw case 122, a drive motor 124, a flat screw 130, a barrel 140, and a heater 150. The plasticizing unit 120 plasticizes at least a part of the material in a solid state supplied from the material supply unit 110, generates a paste-like plasticized material having fluidity, and supplies the plasticized material to the nozzle 160.

Plasticizing is a concept including melting and means changing a solid state to a fluid state. Specifically, in the case of a material in which glass transition occurs, plasticizing means setting the temperature of the material to temperature equal to or higher than the glass transition point. In the case of a material in which glass transition does not occur, plasticizing means setting the temperature of the material to temperature equal to or higher than the melting point.

The screw case 122 is a housing that houses the flat screw 130. The barrel 140 is provided on the lower surface of the screw case 122. The flat screw 130 is housed in a space surrounded by the screw case 122 and the barrel 140.

The drive motor 124 is provided on the upper surface of the screw case 122. The drive motor 124 is, for example, a servo motor. A shaft 126 of the drive motor 124 is coupled to an upper surface 131 of the flat screw 130. The drive motor 124 is controlled by the control unit 70. Although not illustrated, the shaft 126 of the drive motor 124 and the upper surface 131 of the flat screw 130 may be coupled via a speed reducer.

The flat screw 130 has a substantially cylindrical shape, the size of which in a rotation axis R direction is smaller than the size of which in a direction orthogonal to the rotation axis R direction. In the illustrated example, the rotation axis R is parallel to the Z-axis. The flat screw 130 rotates centering on the rotation axis R with torque generated by the drive motor 124.

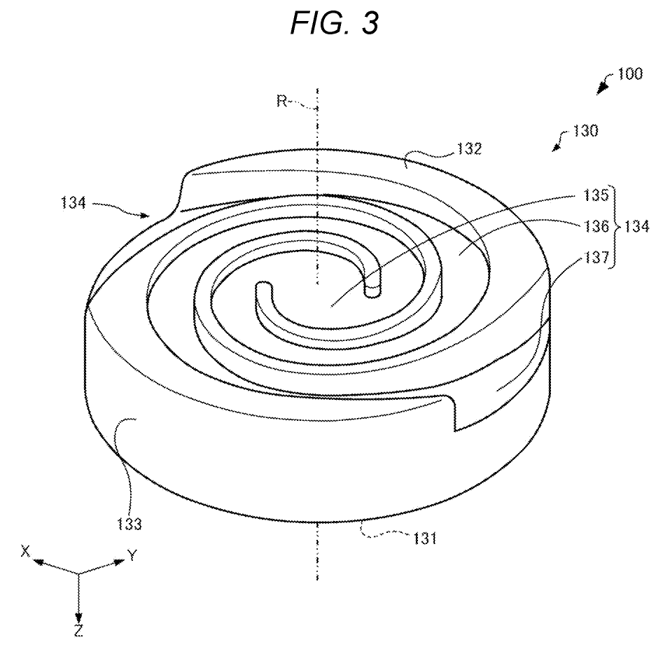

The flat screw 130 includes the upper surface 131, a groove forming surface 132 on the side opposite to the upper surface 131, and a side surface 133 coupling the upper surface 131 and the groove forming surface 132. A first groove 134 is formed on the groove forming surface 132. The side surface 133 is, for example, perpendicular to the groove forming surface 132. Here, FIG. 3 is a perspective view schematically illustrating the flat screw 130. For convenience, in FIG. 3, a state in which an upper-lower positional relationship is reversed from a state illustrated in FIG. 2 is illustrated.

As illustrated in FIG. 3, the first groove 134 is formed on the groove forming surface 132 of the flat screw 130. The first groove 134 includes, for example, a center section 135, a coupling section 136, and a material introduction section 137. The center section 135 faces a communication hole 146 formed in the barrel 140. The center section 135 communicates with the communication hole 146. The coupling section 136 couples the center section 135 and the material introduction section 137. In the illustrated example, the coupling section 136 is provided in a spiral shape from the center section 135 toward the outer circumference of the groove forming surface 132. The material introduction section 137 is provided at the outer circumference of the groove forming surface 132. That is, the material introduction section 137 is provided on the side surface 133 of the flat screw 130. The material supplied from the material supply unit 110 is introduced into the first groove 134 from the material introduction section 137 and is conveyed to, passing through the coupling section 136 and the center section 135, the communication hole 146 formed in the barrel 140. For example, two first grooves 134 are provided.

The number of first grooves 134 is not particularly limited. Although not illustrated, three or more first grooves 134 may be formed or only one first groove 134 may be formed. Although not illustrated, the plasticizing unit 120 may include, rather than the flat screw 130, an elongated in-line screw including a spiral groove on a side surface thereof. The plasticizing unit 120 may plasticize the material with rotation of the in-line screw.

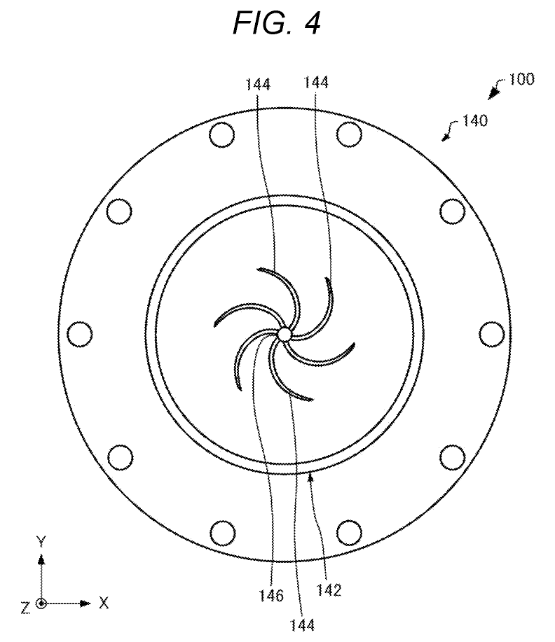

As illustrated in FIG. 2, the barrel 140 is provided below the flat screw 130. The barrel 140 has a facing surface 142 facing the groove forming surface 132 of the flat screw 130. The communication hole 146 communicating with the first groove 134 is formed at the center of the facing surface 142. Here, FIG. 4 is a plan view schematically illustrating the barrel 140.

As illustrated in FIG. 4, a second groove 144 is formed on and the communication hole 146 is formed in the facing surface 142 of the barrel 140. A plurality of second grooves 144 are formed. In an illustrated example, six second grooves 144 are formed. However, the number of second grooves 144 is not particularly limited. The plurality of second grooves 144 are formed around the communication hole 146 when viewed in the Z-axis direction. One end of the second groove 144 is coupled to the communication hole 146 and extends spirally from the communication hole 146 toward the outer circumference of the barrel 140. The second groove 144 has a function of guiding the plasticized material to the communication hole 146.

Although not illustrated, the shape of the second groove 144 is not particularly limited and may be, for example, a linear shape. One end of the second groove 144 may not be coupled to the communication hole 146. Further, the second groove 144 may not be formed on the facing surface 142. However, considering efficient guidance of the plasticized material to the communication hole 146, the second groove 144 is preferably formed on the facing surface 142.

As illustrated in FIG. 2, the heater 150 is provided in the barrel 140. The heater 150 heats the material supplied to between the flat screw 130 and the barrel 140. Output of the heater 150 is controlled by the control unit 70. The plasticizing unit 120 heats the material with the heater 150 while conveying the material toward the communication hole 146 with the flat screw 130 and the barrel 140 to generate a plasticized material. Then, the plasticizing unit 120 causes the generated plasticized material to flow out from the communication hole 146.

Although not illustrated, the shape of the heater 150 may be a ring shape when viewed in the Z-axis direction. The heater 150 may be provided below the barrel 140 rather than in the barrel 140.

The nozzle 160 is provided below the barrel 140. A nozzle flow path 162 is formed in the nozzle 160. The nozzle flow path 162 communicates with the communication hole 146. The plasticized material is supplied to the nozzle flow path 162 from the communication hole 146. The nozzle 160 ejects, from a distal end 164 toward the stage 20, the plasticized material supplied to the nozzle flow path 162. The distal end 164 is the end on the stage 20 side of the nozzle 160. In the illustrated example, the distal end 164 is the end in the -Z-axis direction of the nozzle 160.

A first nozzle 160a and a second nozzle 160b are provided as the nozzles 160. The first nozzle 160a is the nozzle 160 of the first ejection unit 10a. The second nozzle 160b is the nozzle 160 of the second ejection unit 10b. The first nozzle 160a and the second nozzle 160b are disposed side by side in the X-axis direction. In the illustrated example, the first nozzle 160a is located further in the +X-axis direction than the second nozzle 160b. The three-dimensional shaping apparatus 100 manufactures a three-dimensional shaped object by ejecting the plasticized material from the first nozzle 160a and the second nozzle 160b toward the stage 20 and stacking, on the stage 20, a shaping layer formed by the plasticized material.

The valve 170 is provided in the nozzle flow path 162. The valve 170 adjusts an amount of the plasticized material ejected from the nozzle 160. In a state in which the valve 170 is closed, the plasticized material is not ejected from the nozzle 160. In a state in which the valve 170 is opened, the plasticized material is ejected from the nozzle 160. The valve 170 is, for example, a butterfly valve. A first valve 170a is the valve 170 of the first ejection unit 10a. A second valve 170b is the valve 170 of the second ejection unit 10b. When the plasticized material is ejected from the first nozzle 160a, the first valve 170a is opened and the second valve 170b is closed. When the plasticized material is ejected from the second nozzle 160b, the first valve 170a is closed and the second valve 170b is opened.

The stage 20 is provided below the nozzle 160. In the illustrated example, the shape of the stage 20 is a rectangular parallelepiped. The plasticized material is deposited on the stage 20. The material of the stage 20 is metal such as aluminum. In the illustrated example, the Z-axis direction is a direction perpendicular to the stage 20.

The position changing unit 30 supports the stage 20. The position changing unit 30 changes the relative positions of the ejection unit 10 and the stage 20. In the illustrated example, the position changing unit 30 changes the relative positions of the nozzle 160 and the stage 20 in the X-axis direction and the Y-axis direction by moving the stage 20 in the X-axis direction and the Y-axis direction. Further, the position changing unit 30 changes the relative positions of the nozzle 160 and the stage 20 in the Z-axis direction by moving the ejection unit 10 in the Z-axis direction.

The position changing unit 30 includes, for example, a first electric actuator 32, a second electric actuator 34, and a third electric actuator 36. The first electric actuator 32 moves the stage 20 in the X-axis direction. The second electric actuator 34 moves the stage 20 in the Y-axis direction. The third electric actuator 36 moves the ejection unit 10 in the Z-axis direction.

A configuration of the position changing unit 30 is not particularly limited if the relative positions of the ejection unit 10 and the stage 20 can be changed. For example, the position changing unit 30 may be configured to move the stage 20 in the Z-axis direction and move the ejection unit 10 in the X-axis direction and the Y-axis direction. The position changing unit 30 may be configured to move the stage 20 or the ejection unit 10 in the X-axis direction, the Y-axis direction, and the Z-axis direction.

The support unit 40 is coupled to the third electric actuator 36. The support unit 40 supports the ejection unit 10. The position changing unit 30 moves the first ejection unit 10a and the second ejection unit 10b in the Z-axis direction by causing the third electric actuator 36 to move the support unit 40 in the Z-axis direction. The first ejection unit 10a and the second ejection unit 10b are moved in association with the support unit 40.

The heating plate 50 is provided above the stage 20. The heating plate 50 is supported by the support unit 40. Although not illustrated, the support unit 40 may include a pair of support bowls extending in the Y-axis direction. The heating plate 50 may be suspended and supported by the pair of support bowls. The heating plate 50 is moved by the position changing unit 30 in association with the support unit 40. The heating plate 50 overlaps the stage 20 when viewed in the Z-axis direction. The heating plate 50 includes, for example, a rubber heater. The heating plate 50 heats the shaping layer formed on the stage 20. Output of the heating plate 50 is controlled by the control unit 70.

A through hole 52 is formed in the heating plate 50. The through hole 52 penetrates the heating plate 50 in the Z-axis direction. When a three-dimensional shaped object is shaped, the nozzle 160 of the ejection unit 10 is located in the through hole 52. When the three-dimensional shaped object is shaped, the distal end 164 of the nozzle 160 is located below the heating plate 50. In the illustrated example, two through holes 52 are formed to correspond to the two nozzles 160. When the plasticized material is ejected from the first nozzle 160a, the distal end 164 of the first nozzle 160a is located below the heating plate 50 and the distal end 164 of the second nozzle 160b is located above the heating plate 50. When the plasticized material is ejected from the second nozzle 160b, the distal end 164 of the first nozzle 160a is located above the heating plate 50 and the distal end 164 of the second nozzle 160b is located below the heating plate 50.

The drive unit 60 is supported by the support unit 40. The drive unit 60 is coupled to, for example, the ejection unit 10. The drive unit 60 changes relative positions of the nozzle 160 and the heating plate 50. The drive unit 60 changes relative positions of the nozzle 160 and the heating plate 50 in the Z-axis direction by moving the ejection unit 10 in the Z-axis direction. The drive unit 60 includes, for example, a ball screw, a stepping motor, and a linear guide. The drive unit 60 is moved in association with the support unit 40. The drive unit 60 is controlled by the control unit 70.

For example, two drive units 60 are provided to correspond to the two ejection units 10. A first drive unit 60a is the drive unit 60 coupled to the first ejection unit 10a. A second drive unit 60b is the drive unit 60 coupled to the second ejection unit 10b.

The drive unit 60 may change the relative positions of the nozzle 160 and the heating plate 50 in the Z-axis direction by moving the heating plate 50 in the Z-axis direction without moving the ejection unit 10. The drive unit 60 may change the relative positions of the nozzle 160 and the heating plate 50 in the Z-axis direction by moving both of the ejection unit 10 and the heating plate 50 in the Z-axis direction.

The control unit 70 includes, for example, a computer including a processor, a main storage device, and an input/output interface that receives and outputs signals from and to the outside. The control unit 70 exerts various functions, for example, by the processor executing a program read into the main storage device. Specifically, the control unit 70 controls the ejection unit 10, the position changing unit 30, the heating plate 50, and the drive unit 60. The control unit 70 may include a combination of a plurality of circuits rather than the computer.

### 1.2. Operation

### 1.2.1. Overall flow

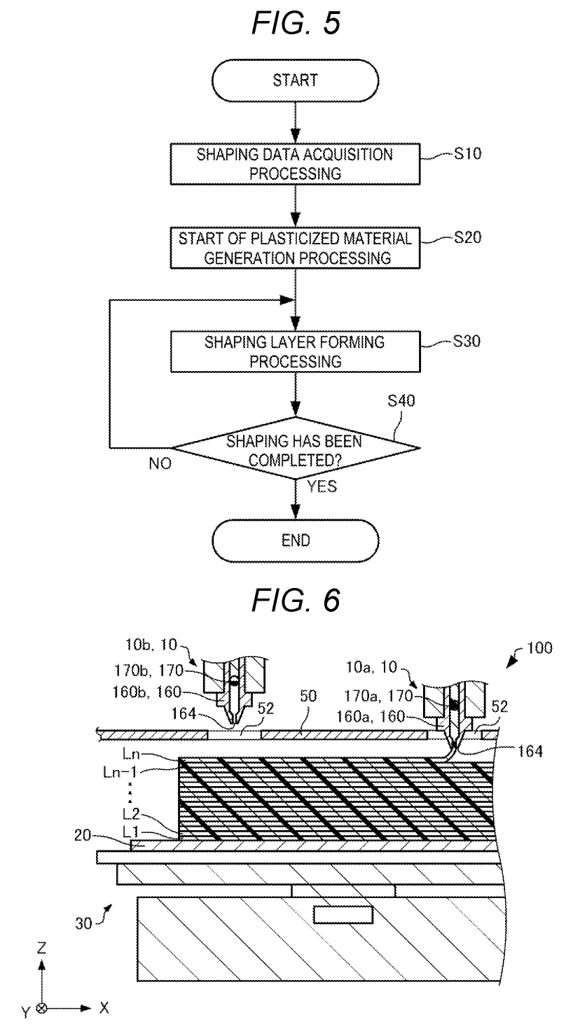

FIG. 5 is a flowchart illustrating an operation of the three-dimensional shaping apparatus 100. Specifically, FIG. 5 is a flowchart illustrating processing by the control unit 70 of the three-dimensional shaping apparatus 100.

For example, the user operates a not-illustrated operation unit to output, to the control unit 70, a processing start signal for starting the processing. The operation unit includes, for example, a mouse, a keyboard, and a touch panel. When receiving the processing start signal, the control unit 70 starts the processing.

First, as illustrated in FIG. 5, in step S10, the control unit 70 performs shaping data acquisition processing of acquiring shaping data for shaping a three-dimensional shaped object.

The shaping data includes information concerning, for example, a type of a material stored in the material supply unit 110, a movement route of the ejection unit 10 with respect to the stage 20, an amount of a plasticized material ejected from the ejection unit 10.

The shaping data is created by, for example, causing slicer software installed in a computer coupled to the three-dimensional shaping apparatus 100 to read shape data. The shape data is data representing a target shape of a three-dimensional shaped object created using three-dimensional computer aided design (CAD) software, three-dimensional computer graphics (CG) software, or the like. As the shape data, data of, for example, a standard triangulated language (STL) format or an additive manufacturing file format (AMF) is used. The slicer software divides the target shape of the three-dimensional shaped object into layers having predetermined thicknesses and creates shaping data for each of the layers. The shaping data is represented by a G code, an M code, or the like. The control unit 70 acquires the shaping data from the computer coupled to the three-dimensional shaping apparatus 100 or a recording medium such as a universal serial bus (USB) memory.

Subsequently, in step S20, the control unit 70 starts plasticized material generation processing of plasticizing a material to generate a plasticized material. Specifically, the control unit 70 drives the drive motor 124 and the heater 150 to plasticize the material supplied from the material supply unit 110 to the plasticizing unit 120 and generate the plasticized material. The control unit 70 continues to generate the plasticized material until shaping layer forming processing ends.

Subsequently, in step S30, the control unit 70 performs shaping layer forming processing of ejecting the plasticized material from the nozzle 160 toward the stage 20 to form a shaping layer while moving the nozzle 160 relatively to the stage 20 in at least one of the X-axis direction and the Z-axis direction.

Here, FIG. 6 is a cross-sectional view illustrating the shaping layer forming processing by the control unit 70 of the three-dimensional shaping apparatus 100.

As illustrated in FIG. 6, while controlling the position changing unit 30 to change the relative positions of the ejection unit 10 and the stage 20, the control unit 70 controls, based on the acquired shaping data, the ejection unit 10 to eject the plasticized material from the nozzle 160 toward the stage 20.

Specifically, before the shaping layer forming processing is started, that is, before formation of a shaping layer L1, which is a first shaping layer, is started, the nozzle 160 is disposed at an initial position further in the -X-axis direction than the end portion in the -X-axis direction of the stage 20. When the shaping layer forming processing is started, as illustrated in FIG. 6, the control unit 70 controls the position changing unit 30 to, for example, move the nozzle 160 relatively to the stage 20 in the +X-axis direction. When the nozzle 160 passes over the stage 20, the plasticized material is ejected from the nozzle 160. Accordingly, the shaping layer L1 is formed. In FIG. 6, shaping layers up to an n-th shaping layer Ln are illustrated, where n is any natural number. While the shaping layer forming processing is performed, the heating plate 50 is driven.

In an illustrated example, the plasticized material is ejected from the first nozzle 160a of the first ejection unit 10a to form a shaping layer. The distal end 164 of the first nozzle 160a is located below the heating plate 50. The distal end 164 of the second nozzle 160b is located above the heating plate 50. The first valve 170a is opened. The second valve 170b is closed.

Subsequently, as illustrated in FIG. 5, in step S40, the control unit 70 performs determination processing of determining, based on the shaping data, whether the formation of all the shaping layers has been completed.

When determining that the formation of all the shaping layers has not been completed ("NO" in step S40), the control unit 70 returns the processing to step S30. The control unit 70 repeats step S30 and step S40 until determining in step S40 that the formation of all the shaping layers has been completed.

On the other hand, when determining that the formation of all the shaping layers has been completed ("YES" in step S40), the control unit 70 ends the processing.

### 1.2.2. Details of the shaping layer forming processing

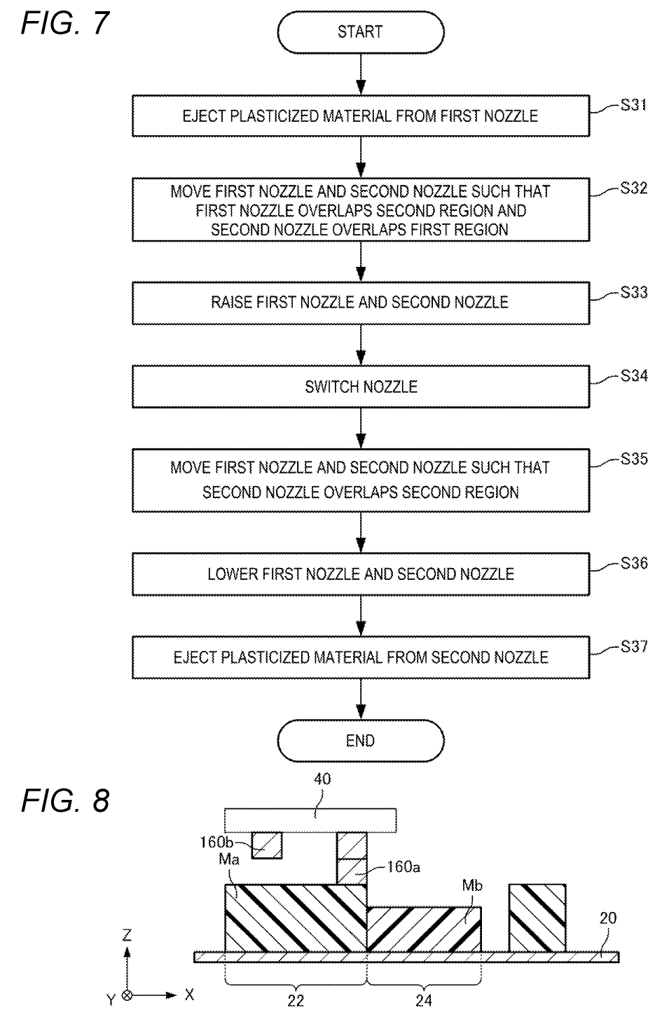

FIG. 7 is a flowchart illustrating the shaping layer forming processing by the control unit 70 of the three-dimensional shaping apparatus 100. FIGS. 8 to 15 are cross-sectional views illustrating the shaping layer forming processing by the control unit 70.

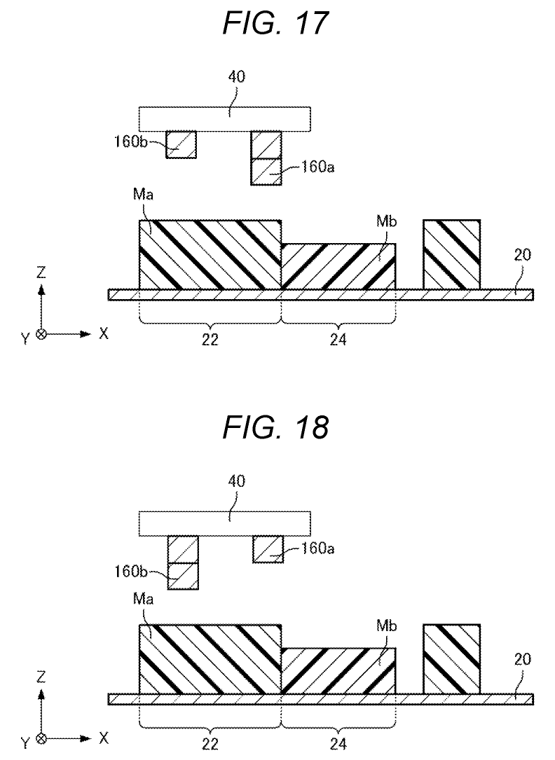

For convenience, in FIGS. 8 to 15, members other than the first nozzle 160a, the second nozzle 160b, the stage 20, and the support unit 40 are not illustrated. The first nozzle 160a, the second nozzle 160b, and the support unit 40 are illustrated in a simplified manner. The same applies to FIGS. 17, 18, 20, 21, 23, 24 referred to below.

After starting the plasticized material generation processing, as illustrated in FIG. 7, in step S31, the control unit 70 performs processing of ejecting the plasticized material from the first nozzle 160a. Specifically, the control unit 70 causes the first ejection unit 10a to eject the plasticized material from the first nozzle 160a toward a first region 22 of the stage 20.

Accordingly, as illustrated in FIG. 8, a first shaped object Ma including a plurality of shaping layers is formed in the first region 22 of the stage 20. The first nozzle 160a is located below the second nozzle 160b. Specifically, the distal end 164 of the first nozzle 160a is located below the heating plate 50 and the distal end 164 of the second nozzle 160b is located above the heating plate 50. The first valve 170a is opened and the second valve 170b is closed.

In an illustrated example, a second shaped object Mb including a plurality of shaping layers is formed in a second region 24 of the stage 20. The number of shaping layers in the second shaped object Mb is smaller than the number of shaping layers in the first shaped object Ma. For that reason, the height in the Z-axis direction of the second shaped object Mb is smaller than the height in the Z-axis direction of the first shaped object Ma. The second region 24 is a region different from the first region 22. The second region 24 is in contact with, for example, the first region 22.

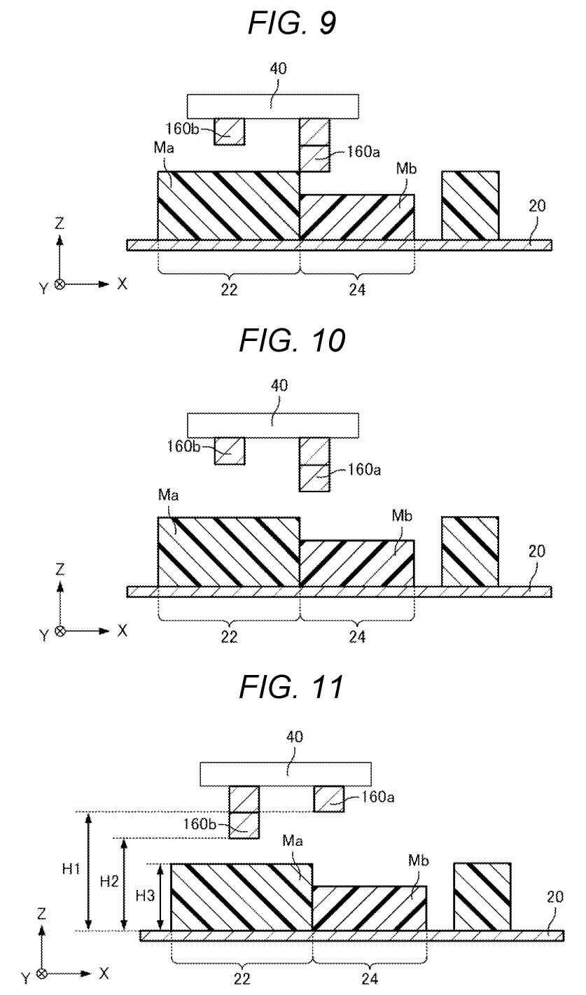

Subsequently, in step S32, as illustrated in FIG. 9, the control unit 70 controls the position changing unit 30 to perform processing of moving the first nozzle 160a and the second nozzle 160b relatively to the stage 20 in the X-axis direction such that the first nozzle 160a overlaps the second region 24 and the second nozzle 160b overlaps the first region 22 when viewed in the Z-axis direction. Specifically, the control unit 70 moves the first nozzle 160a and the second nozzle 160b relatively to the stage 20 in the +X-axis direction.

Subsequently, in step S33, as illustrated in FIG. 10, the control unit 70 controls the position changing unit 30 to perform processing of raising the first nozzle 160a and the second nozzle 160b relatively to the stage 20 in the Z-axis direction.

Subsequently, in step S34, as illustrated in FIG. 11, the control unit 70 performs processing of raising the first nozzle 160a in the Z-axis direction and lowering the second nozzle 160b in the Z-axis direction to switch the nozzle 160. Specifically, the control unit 70 controls the first drive unit 60a to raise the first nozzle 160a in the Z-axis direction and controls the second drive unit 60b to lower the second nozzle 160b in the Z-axis direction. Accordingly, the distal end 164 of the first nozzle 160a is located above the heating plate 50 and the distal end 164 of the second nozzle 160b is located below the heating plate 50. In this way, the control unit 70 switches the nozzle 160.

The switching of the nozzle 160 by the control unit 70 is performed at a position where height H1 in the Z-axis direction of the distal end 164 of the first nozzle 160a and height H2 in the Z-axis direction of the distal end 164 of the second nozzle 160b are higher than height H3 in the Z-axis direction of the shaped objects Ma and Mb including the shaping layers. The height H3 means a maximum height of the shaped object formed on the stage 20. In an illustrated example, the heights H1, H2, and H3 are heights from the upper surface of the stage 20.

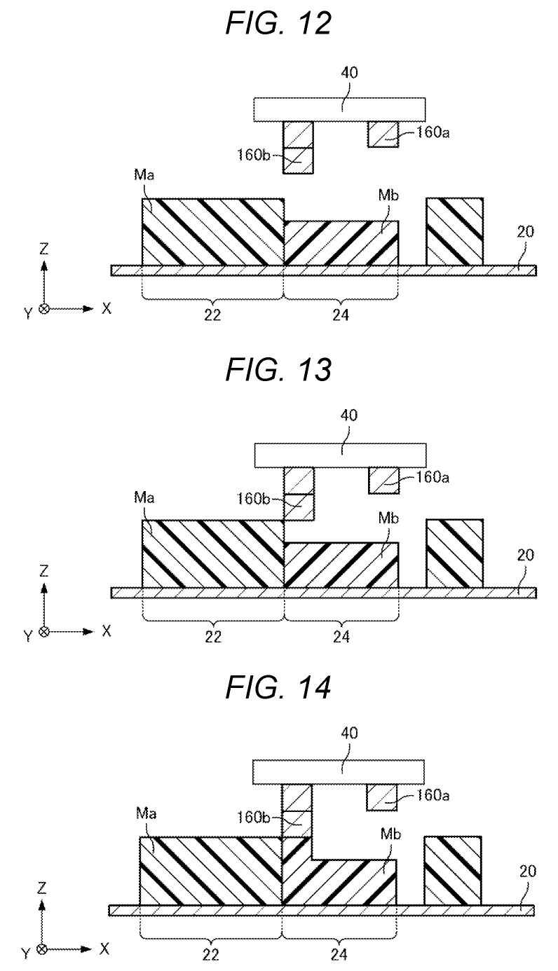

Subsequently, in step S35, as illustrated in FIG. 12, the control unit 70 controls the position changing unit 30 to perform processing of moving the first nozzle 160a and the second nozzle 160b relatively to the stage 20 in the X-axis direction such that the second nozzle 160b overlaps the second region 24 when viewed in the Z-axis direction. Specifically, the control unit 70 moves the first nozzle 160a and the second nozzle 160b relatively to the stage 20 in the +X-axis direction. In an illustrated example, the first nozzle 160a overlaps the second region 24 when viewed in the Z-axis direction.

Subsequently, in step S36, as illustrated in FIG. 13, the control unit 70 controls the position changing unit 30 to perform processing of lowering the first nozzle 160a and the second nozzle 160b relatively to the stage 20 in the Z-axis direction.

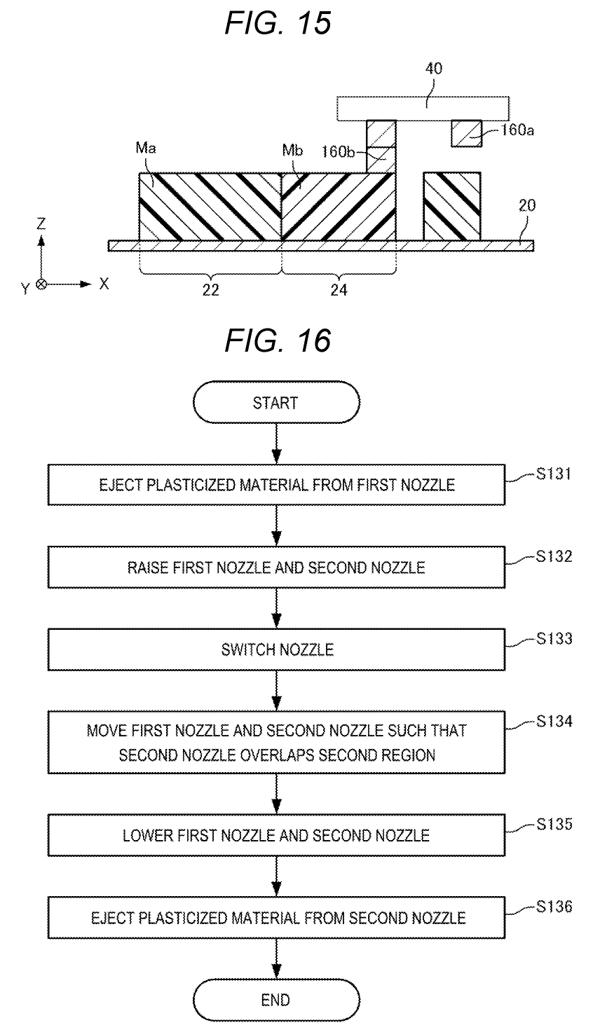

Subsequently, in step S37, as illustrated in FIGS. 14 and 15, the control unit 70 performs processing of ejecting the plasticized material from the second nozzle 160b. Specifically, in a state in which the first valve 170a is closed and the second valve 170b is opened, the control unit 70 controls the position changing unit 30 to cause the second ejection unit 10b to eject the plasticized material from the second nozzle 160b toward the second region 24 while moving the first nozzle 160a and the second nozzle 160b relatively to the stage 20 in the +X-axis direction. Accordingly, for example, the number of shaping layers in the second shaped object Mb is the same as the number of shaping layers in the first shaped object Ma. Opening and closing timing of the valves 170a and 170b is not particularly limited. However, the valves 170a and 170b are opened and closed, for example, at switching timing of the nozzle 160.

The control unit 70 ends the shaping layer forming processing.

In the three-dimensional shaped object manufacturing method according to the present embodiment, for example, it is possible to manufacture the three-dimensional shaped object using the three-dimensional shaping apparatus 100 explained above.

### 1.3. Action effects

The three-dimensional shaped object manufacturing method according to the present embodiment includes a plasticizing step of plasticizing a material to generate a plasticized material and an ejecting step of ejecting the plasticized material from the first nozzle 160a and the second nozzle 160b toward the stage 20 while moving the first nozzle 160a and the second nozzle 160b relatively to the stage 20 in the X-axis direction serving as the first axial direction. The ejecting step includes a first ejecting step of ejecting the plasticized material from the first nozzle 160a, a nozzle switching step of raising the first nozzle 160a in the Z-axis direction perpendicular to the stage 20 and lowering the second nozzle 160b in the Z-axis direction after the first ejecting step, and a second ejecting step of ejecting the plasticized material from the second nozzle 160b after the nozzle switching step. The nozzle switching step is performed at a position where the height H1 in the Z-axis direction of the distal end 164 of the first nozzle 160a and the height H2 in the Z-axis direction of the distal end 164 of the second nozzle 160b are higher than the height H3 in the Z-axis direction of the shaped objects Ma and Mb including the shaping layers.

For that reason, in the three-dimensional shaped object manufacturing method according to the present embodiment, when the first nozzle 160a is switched to the second nozzle 160b, it is possible to prevent the second nozzle 160b from coming into contact with the shaped objects Ma and Mb formed on the stage 20. Accordingly, it is possible to reduce the likelihood of occurrence of shaping failure. Although the first axial direction is the X-axis direction in the above explanation, the first axial direction is not particularly limited if the first axial direction is a direction orthogonal to the Z-axis direction and may be the Y-axis direction.

In the three-dimensional shaped object manufacturing method according to the present embodiment, in the first ejecting step, the plasticized material is ejected toward the first region 22 of the stage 20, the ejecting step includes a first moving step of, after the nozzle switching step, moving the first nozzle 160a and the second nozzle 160b relatively to the stage 20 in the X-axis direction such that the second nozzle 160b overlaps the second region 24 different from the first region 22 of the stage 20 when viewed in the Z-axis direction, and the second ejecting step ejects the plasticized material toward the second region 24 after the first moving step. For that reason, in the three-dimensional shaped object manufacturing method according to the present embodiment, it is possible to eject the plasticized material from the second nozzle 160b toward the second region 24.

In the three-dimensional shaped object manufacturing method according to the present embodiment, the ejecting step includes a second moving step of, after the first ejecting step, moving the first nozzle 160a and the second nozzle 160b relatively to the stage 20 in the X-axis direction such that the first nozzle 160a overlaps the second region 24 and the second nozzle 160b overlaps the first region 22 when viewed in the Z-axis direction, and the nozzle switching step is performed after the second moving step. For that reason, in the three-dimensional shaped object manufacturing method according to the present embodiment, when the first nozzle 160a is switched to the second nozzle 160b, it is possible to prevent the second nozzle 160b from coming into contact with the shaped objects Ma and Mb formed on the stage 20.

In the three-dimensional shaped object manufacturing method according to the present embodiment, the ejecting step includes a raising step of raising the first nozzle 160a and the second nozzle 160b relatively to the stage 20 in the Z-axis direction after the first ejecting step, and the nozzle switching step is performed after the raising step. For that reason, in the three-dimensional shaped object manufacturing method according to the present embodiment, when the first nozzle 160a is switched to the second nozzle 160b, it is possible to prevent the second nozzle 160b from coming into contact with the shaped objects Ma and Mb formed on the stage 20.

The nozzle switching step may be performed during the raising step. The control unit 70 may simultaneously perform the processing of switching the nozzle 160 and the processing of raising the first nozzle 160a and the second nozzle 160b relatively to the stage 20 in the Z-axis direction. Accordingly, it is possible to reduce a manufacturing time for the three-dimensional shaped object.

In the three-dimensional shaped object manufacturing method according to the present embodiment, the second nozzle 160b overlaps the first region 22 when viewed in the Z-axis direction after the first ejecting step and before the nozzle switching step. As explained above, even when the second nozzle 160b overlaps the first region 22, in the three-dimensional shaped object manufacturing method according to the present embodiment, since the nozzle switching step is performed at the position where the height H1 in the Z-axis direction of the distal end 164 of the first nozzle 160a and the height H2 in the Z-axis direction of the distal end 164 of the second nozzle 160b are higher than the height H3 in the Z-axis direction of the shaped objects Ma and Mb including the shaping layers, it is possible to prevent the second nozzle 160b from coming into contact with the shaped objects Ma and Mb formed on the stage 20.

### 2. Modification of the shaping layer forming processing

### 2.1. First modification

Next, a first modification of the shaping layer forming processing by the control unit 70 of the three-dimensional shaping apparatus 100 according to the present embodiment is explained with reference to the drawings. FIG. 16 is a flowchart illustrating the first modification of the shaping layer forming processing by the control unit 70. FIGS. 17 and 18 are cross-sectional views illustrating the first modification of the shaping layer forming processing by the control unit 70.

Hereinafter, in the first modification of the shaping layer forming processing by the control unit 70 of the three-dimensional shaping apparatus 100 according to the present embodiment, differences from the example of the shaping layer forming processing by the control unit 70 of the three-dimensional shaping apparatus 100 according to the present embodiment explained above are explained and explanation is simplified or omitted about similarities to the example.

The first modification of the shaping layer forming processing by the control unit 70 is different from the shaping layer forming processing by the control unit 70 explained above in that processing equivalent to step S32 illustrated in FIG. 7 is not performed.

As illustrated in FIG. 16, in step S131, the control unit 70 performs processing of ejecting the plasticized material from the first nozzle 160a toward the first region 22. The processing in step S131 is basically the same as the processing in step S31 explained above.

Subsequently, in step S132, as illustrated in FIG. 17, the control unit 70 performs processing of raising the first nozzle 160a and the second nozzle 160b relatively to the stage 20 in the Z-axis direction. The processing in step S132 is basically the same as the processing in step S33 explained above.

Subsequently, in step S133, the control unit 70 performs processing of switching the nozzle 160 as illustrated in FIG. 18. The processing in step S133 is basically the same as the processing in step S34 explained above.

Subsequently, as illustrated in FIG. 12, in step S134, the control unit 70 performs processing of moving the first nozzle 160a and the second nozzle 160b relatively to the stage 20 in the X-axis direction such that the second nozzle 160b overlaps the second region 24. The processing in step S134 is basically the same as the processing in step S35 explained above.

Subsequently, in step S135, the control unit 70 performs processing of lowering the first nozzle 160a and the second nozzle 160b relatively to the stage 20 in the Z-axis direction. The processing in step S135 is basically the same as the processing in step S36 explained above.

Subsequently, in step S136, the control unit 70 performs processing of ejecting the plasticized material from the second nozzle 160b toward the second region 24. The processing in step S136 is basically the same as the processing in step S37 explained above.

The control unit 70 ends the shaping layer forming processing.

In the three-dimensional shaped object manufacturing method according to the first modification of the present embodiment, for example, the three-dimensional shaped object can be manufactured by the first modification of the shaping layer forming processing by the control unit 70.

In the three-dimensional shaped object manufacturing method according to the first modification of the present embodiment, since a step equivalent to step S32 illustrated in FIG. 7 is not performed, it is possible to reduce a manufacturing time for the three-dimensional shaped object.

### 2.2. Second modification

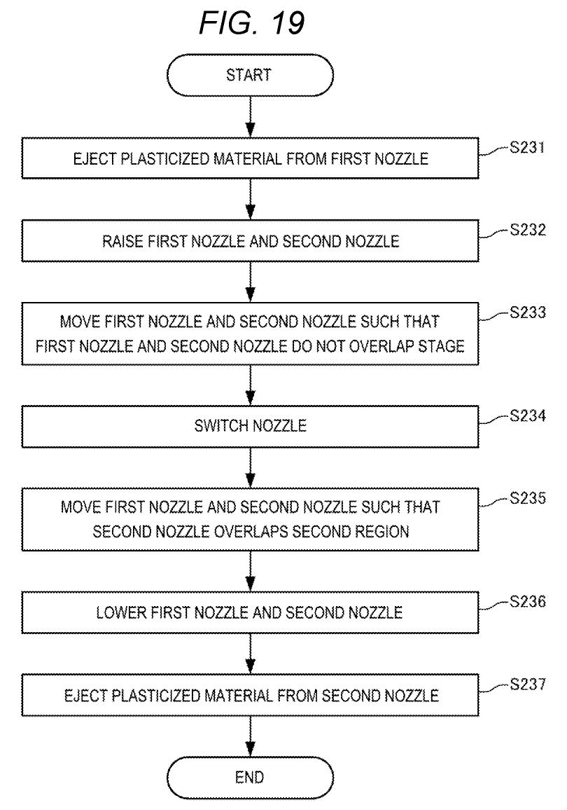

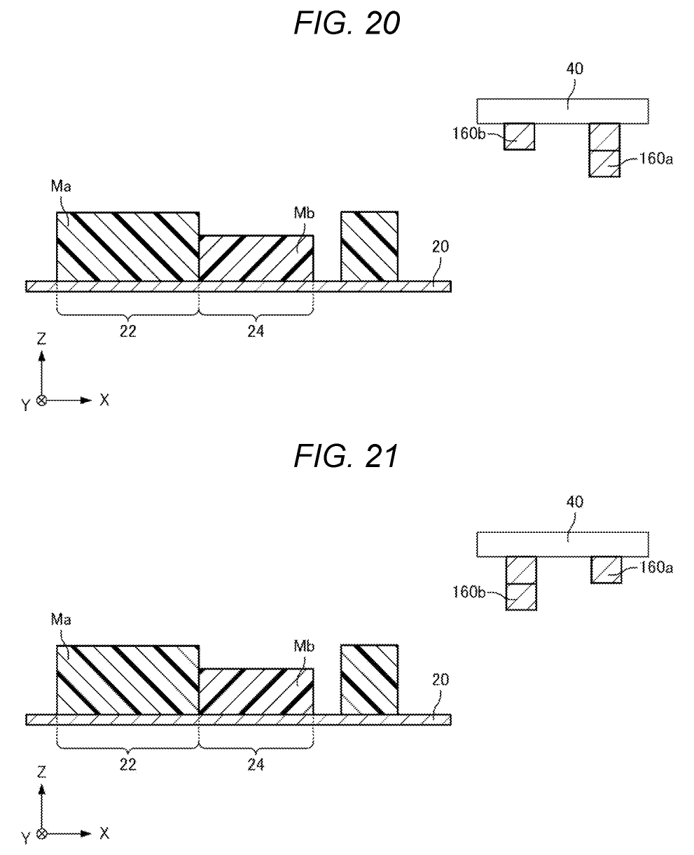

Next, a second modification of the shaping layer forming processing by the control unit 70 of the three-dimensional shaping apparatus 100 according to the present embodiment is explained with reference to the drawings. FIG. 19 is a flowchart illustrating the second modification of the shaping layer forming processing by the control unit 70. FIGS. 20 and 21 are cross-sectional views illustrating the second modification of the shaping layer forming processing by the control unit 70.

Hereinafter, in the second modification of the shaping layer forming processing by the control unit 70 of the three-dimensional shaping apparatus 100 according to the present embodiment, differences from the example of the first modification of the shaping layer forming processing by the control unit 70 of the three-dimensional shaping apparatus 100 according to the present embodiment explained above are explained and explanation is simplified or omitted about similarities to the example.

The second modification of the shaping layer forming processing by the control unit 70 is different from the first modification of the shaping layer forming processing by the control unit 70 explained above in that the switching of the nozzle 160 is performed at a position where the nozzle 160 does not overlap the stage 20 when viewed in the Z-axis direction as illustrated in FIGS. 20 and 21.

As illustrated in FIG. 19, in step S231, the control unit 70 performs processing of ejecting the plasticized material from the first nozzle 160a toward the first region 22. The processing in step S231 is basically the same as the processing in step S131 explained above.

Subsequently, in step S232, the control unit 70 performs processing of raising the first nozzle 160a and the second nozzle 160b relatively to the stage 20 in the Z-axis direction. The processing in step S232 is basically the same as the processing in step S132 explained above.

Subsequently, in step S233, as illustrated in FIG. 20, the control unit 70 performs processing of moving the first nozzle 160a and the second nozzle 160b relatively to the stage 20 in the X-axis direction such that the first nozzle 160a does not overlap the first region 22 and the second region 24 and the second nozzle 160b does not overlap the first region 22 and the second region 24 when viewed in the Z-axis direction. Specifically, the control unit 70 moves the first nozzle 160a and the second nozzle 160b relatively to the stage 20 in the +X-axis direction. In an illustrated example, the first nozzle 160a and the second nozzle 160b do not overlap the stage 20 when viewed in the Z-axis direction.

Subsequently, in step S234, the control unit 70 performs processing of switching the nozzle 160 as illustrated in FIG. 21. The processing in step S234 is basically the same as the processing in step S133 explained above.

Subsequently, in step S235, as illustrated in FIG. 12, the control unit 70 performs processing of moving the first nozzle 160a and the second nozzle 160b relatively to the stage 20 such that the second nozzle 160b overlaps the second region 24 when viewed in the Z-axis direction. Specifically, the control unit 70 moves the first nozzle 160a and the second nozzle 160b relatively to the stage 20 in the -X-axis direction.

Subsequently, in step S236, the control unit 70 lowers the first nozzle 160a and the second nozzle 160b relatively to the stage 20 in the Z-axis direction. The processing in step S236 is basically the same as the processing in step S135 explained above.

Subsequently, in step S237, the control unit 70 performs processing of ejecting the plasticized material from the second nozzle 160b toward the second region 24. The processing in step S237 is basically the same as the processing in step S136 explained above.

The control unit 70 ends the shaping layer forming processing.

In the three-dimensional shaped object manufacturing method according to the second modification of the present embodiment, for example, the three-dimensional shaped object can be manufactured by the second modification of the shaping layer forming processing by the control unit 70.

In the three-dimensional shaped object manufacturing method according to the second modification of the present embodiment, the ejecting step includes a third moving step of, after the raising step, moving the first nozzle 160a and the second nozzle 160b relatively to the stage 20 in the X-axis direction such that the first nozzle 160a does not overlap the first region 22 and the second region 24 and the second nozzle 160b does not overlap the first region 22 and the second region 24 when viewed in the Z-axis direction. For that reason, in the three-dimensional shaped object manufacturing method according to the second modification of the present embodiment, even if dust adheres to the nozzle 160, it is possible to reduce the likelihood that the dust falls on the shaped objects Ma and Mb when the nozzle 160 is switched.

In the three-dimensional shaped object manufacturing method according to the second modification of the present embodiment, in the third moving step, the first nozzle 160a and the second nozzle 160b are moved relatively to the stage 20 in the X-axis direction such that the first nozzle 160a and the second nozzle 160b do not overlap the stage 20 when viewed in the Z-axis direction. For that reason, in the three-dimensional shaped object manufacturing method according to the second modification of the present embodiment, even if dust adheres to the nozzle 160, it is possible to reduce the likelihood that the dust falls on the stage 20 when the nozzle 160 is switched.

### 2.3. Third modification

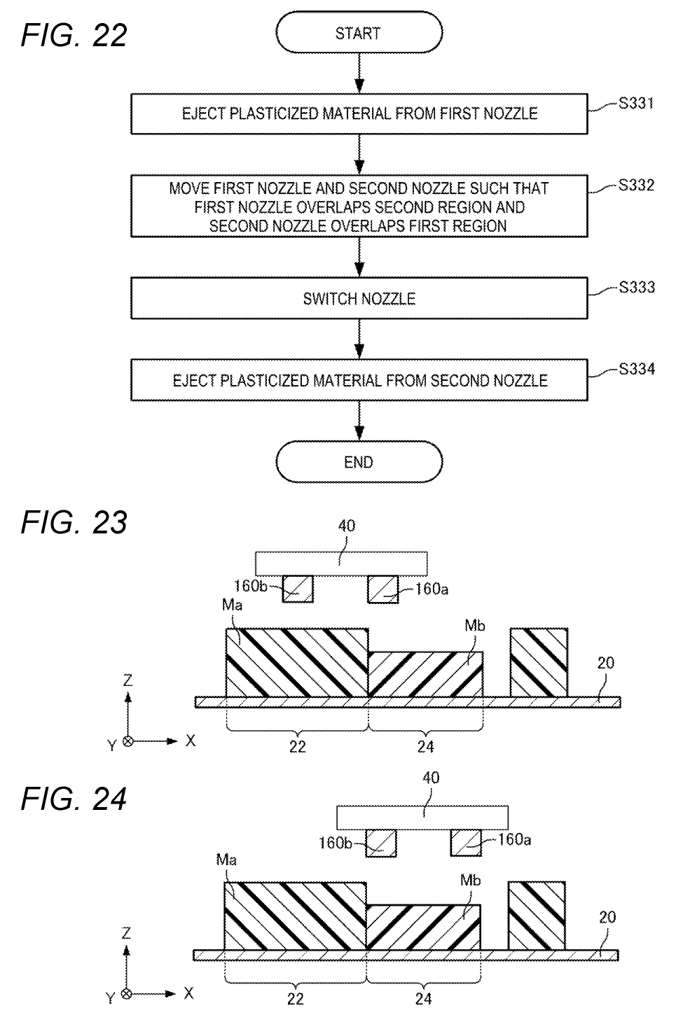

Next, a third modification of the shaping layer forming processing by the control unit 70 of the three-dimensional shaping apparatus 100 according to the present embodiment is explained with reference to the drawings. FIG. 22 is a flowchart illustrating a third modification of the shaping layer forming processing by the control unit 70. FIGS. 23 and 24 are cross-sectional views illustrating the third modification of the shaping layer forming processing by the control unit 70.

Hereinafter, in the third modification of the shaping layer forming processing by the control unit 70 of the three-dimensional shaping apparatus 100 according to the present embodiment, differences from the example of the shaping layer forming processing by the control unit 70 of the three-dimensional shaping apparatus 100 according to the present embodiment explained above are explained and explanation is simplified or omitted about similarities to the example.

The third modification of the shaping layer forming processing by the control unit 70 is different from the shaping layer forming processing by the control unit 70 explained above in that processing equivalent to step S33 illustrated in FIG. 7 and processing equivalent to step S36 illustrated in FIG. 7 are not performed.

As illustrated in FIG. 22, in step S331, the control unit 70 performs processing of ejecting the plasticized material from the first nozzle 160a toward the first region 22. The processing in step S331 is basically the same as the processing in step S31 explained above.

Subsequently, in step S332, as illustrated in FIG. 9, the control unit 70 performs processing of moving the first nozzle 160a and the second nozzle 160b relatively to the stage 20 in the X-axis direction such that the first nozzle 160a overlaps the second region 24 and the second nozzle 160b overlaps the first region 22 when viewed in the Z-axis direction. The processing in step S332 is basically the same as the processing in step S32 explained above.

Subsequently, in step S333, the control unit 70 performs processing of switching the nozzle 160. Specifically, the control unit 70 controls the first drive unit 60a to raise the first nozzle 160a in the Z-axis direction as illustrated in FIG. 23. Subsequently, the control unit 70 controls the position changing unit 30 to move the first nozzle 160a and the second nozzle 160b relatively to the stage 20 in the X-axis direction such that the second nozzle 160b overlaps the second region 24 when viewed in the Z-axis direction as illustrated in FIG. 24. Specifically, the control unit 70 moves the first nozzle 160a and the second nozzle 160b relatively to the stage 20 in the +X-axis direction. Subsequently, the control unit 70 controls the second drive unit 60b to lower the second nozzle 160b in the Z-axis direction as illustrated in FIG. 13.

Subsequently, in step S334, the control unit 70 performs processing of ejecting the plasticized material from the second nozzle 160b toward the second region 24. The processing in step S334 is basically the same as the processing in step S37 explained above.

The control unit 70 ends the shaping layer forming processing.

In the three-dimensional shaped object manufacturing method according to the third modification of the present embodiment, for example, the three-dimensional shaped object can be manufactured by the third modification of the shaping layer forming processing by the control unit 70.

In the three-dimensional shaped object manufacturing method according to the third modification of the present embodiment, in the nozzle switching step, after the first nozzle 160a is raised in the Z-axis direction, the first nozzle 160a and the second nozzle 160b are moved relatively to the stage 20 in the X-axis direction and the second nozzle 160b is lowered in the Z-axis direction such that the second nozzle 160b overlaps the second region 24 different from the first region 22 of the stage 20 when viewed in the Z-axis direction. For that reason, in the three-dimensional shaped object manufacturing method according to the third modification of the present embodiment, since the first nozzle 160a and the second nozzle 160b are not raised and lowered relatively to the stage 20 in the Z-axis direction in order to switch the nozzle 160, it is possible to reduce a manufacturing time for the three-dimensional shaped object.

In the above explanation, an example is explained in which the shaping data is created by the slicer software installed in the computer coupled to the three-dimensional shaping apparatus 100. However, the shaping data may be created by the three-dimensional shaping apparatus 100 or may be created by both of the three-dimensional shaping apparatus 100 and the slicer software installed in the computer coupled to the three-dimensional shaping apparatus 100. The control unit 70 may control the ejection unit 10 and the position changing unit 30 based on data created by the three-dimensional shaping apparatus 100 besides the shaping data.

### 3. Modification of the material of the three-dimensional shaping apparatus

Next, a modification of the material of the three-dimensional shaping apparatus 100 according to the present embodiment is explained.

In the three-dimensional shaping apparatus 100 explained above, the material supplied from the material supply unit 110 to the plasticizing unit 120 is the ABS resin. However, the material supplied from the material supply unit 110 to the plasticizing unit 120 may be a material other than the ABS resin or a material obtained by adding another component to the ABS resin.

Examples of the material supplied from the material supply unit 110 include materials containing various materials such as a thermoplastic material, a metal material, and a ceramic material as main materials. Here, the "main material" means a material mainly forming the shape of the three-dimensional shaped object manufactured by the three-dimensional shaping apparatus 100 and means a material that accounts for a content of 50 mass% or more in the three-dimensional shaped object. The materials explained above include materials obtained by melting the main materials alone and materials obtained by melting some of components contained together with the main materials into a paste form.

Examples of the thermoplastic material include thermoplastic resin. Examples of the thermoplastic resin include general-purpose plastic, general-purpose engineering plastic, and super engineering plastic.

Examples of the general-purpose plastic include polypropylene (PP), polyethylene (PE), polyvinyl chloride (PVC), and polylactic acid (PLA).

Examples of the general-purpose engineering plastic include polyacetal (POM), polyamide (PA), polycarbonate (PC), modified polyphenylene ether (m-PPE), polybutylene terephthalate (PBT), and polyethylene terephthalate (PET).

Examples of the super engineering plastic include polysulfone (PSU), polyethersulfone (PES), polyphenylene sulfide (PPS), polyarylate (PAR), polyimide (PI), polyamideimide (PAI), polyetherimide (PEI), and polyetheretherketone (PEEK).

Pigment, metal, and ceramic and, besides, additives such as a wax, a flame retardant, an antioxidant, and a heat stabilizer may be mixed in the thermoplastic material. In the plasticizing unit 120, the thermoplastic material is plasticized and converted into a molten state by rotation of the flat screw 130 and heating of the heater 150. The plasticized material generated as explained above is ejected from the nozzle 160 and deposited on the stage 20 and is thereafter cured by a temperature drop.

In the plasticizing unit 120, for example, a metal material may be used as the main material instead of the thermoplastic material explained above. In this case, it is desirable that a powder material obtained by powdering the metal material is mixed with a component that melts in generation of the plasticized material and a mixture of the powder material and the component is put in the plasticizing unit 120.

Examples of the metal material include single metal such as magnesium (Mg), iron (Fe), cobalt (Co), chromium (Cr), aluminum (Al), titanium (Ti), copper (Cu), and nickel (Ni) or an alloy containing one or more of these kinds of metal, maraging steel, stainless steel, cobalt chromium molybdenum, a titanium alloy, a nickel alloy, an aluminum alloy, a cobalt alloy, and a cobalt chromium alloy.

In the plasticizing unit 120, a ceramic material can be used as the main material instead of the metal material explained above. Examples of the ceramic material include oxide ceramic such as silicon dioxide, titanium dioxide, aluminum oxide, and zirconium oxide and non-oxide ceramic such as aluminum nitride.

A powder material of the metal material or the ceramic material supplied from the material supply unit 110 may be a mixed material obtained by mixing a plurality of kinds of powder of the single metal, powder of the alloy, or powder of the ceramic material. The powder material of the metal material or the ceramic material may be coated with, for example, the thermoplastic resin explained above or other thermoplastic resin. In this case, in the plasticizing unit 120, the thermoplastic resin may melt to exhibit fluidity.

For example, a solvent can be added to the powder material of the metal material or the ceramic material supplied from the material supply unit 110. Examples of the solvent include: water; (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ-picoline, and 2,6-lutidine; tetraalkylammonium acetates (for example, tetrabutylammonium acetate); and ionic liquids such as butyl carbitol acetate.

Besides, for example, a binder may be added to the powder material of the metal material or the ceramic material supplied from the material supply unit 110. Examples of the binder include acrylic resin, epoxy resin, silicone resin, cellulose-based resin, and other synthetic resin and PLA, PA, PPS, PEEK, and other thermoplastic resin.

The embodiment and modifications explained above are merely examples and the present disclosure is not limited thereto. For example, it is also possible to combine the embodiment and the modifications as appropriate.

The present disclosure includes a configuration that is substantially the same as the configuration explained in the embodiment, for example, functions, methods, and results of which are the same as those of the configuration, or objects and effects of which are the same as those of the configuration. The present disclosure further includes a configuration in which non-essential portions of the configuration explained in the embodiment are replaced with other portions. The present disclosure includes a configuration that has the same action effects as those of the configuration explained in the embodiment or a configuration that can achieve the same objects as those achieved by the configuration. The present disclosure includes a configuration obtained by adding a publicly-known technique to the configuration explained in the embodiment.

The following contents are derived from the embodiment and the modifications explained above.

According to an aspect of the present disclosure, there is provided a three-dimensional shaped object manufacturing method for manufacturing a three-dimensional shaped object by ejecting a plasticized material from a first nozzle and a second nozzle disposed side by side in a first axial direction toward a stage and stacking a shaping layer formed by the plasticized material on the stage, the three-dimensional shaped object manufacturing method including: a plasticizing step of plasticizing a material to generate the plasticized material; and an ejecting step of ejecting the plasticized material from the first nozzle and the second nozzle toward the stage while moving the first nozzle and the second nozzle relatively to the stage in the first axial direction, wherein the ejecting step includes: a first ejecting step of ejecting the plasticized material from the first nozzle; a nozzle switching step of raising the first nozzle in a second axial direction perpendicular to the stage and lowering the second nozzle in the second axial direction after the first ejecting step; and a second ejecting step of ejecting the plasticized material from the second nozzle after the nozzle switching step, and the nozzle switching step is performed at a position where height in the second axial direction of a distal end of the first nozzle and height in the second axial direction of a distal end of the second nozzle are higher than height in the second axial direction of a shaped object including the shaping layer.

With the three-dimensional shaped object manufacturing method, it is possible to reduce the likelihood of occurrence of shaping failure.

In the three-dimensional shaped object manufacturing method according to the aspect, in the first ejecting step, the plasticized material may be ejected toward a first region of the stage, the ejecting step may include a first moving step of, after the nozzle switching step, moving the first nozzle and the second nozzle relatively to the stage in the first axial direction such that the second nozzle overlaps a second region different from the first region of the stage when viewed in the second axial direction, and, in the second ejecting step, the plasticized material may be ejected toward the second region after the first moving step.

With the three-dimensional shaped object manufacturing method, it is possible to eject the plasticized material from the second nozzle toward the second region.

In the three-dimensional shaped object manufacturing method according to the aspect, the ejecting step may include a second moving step of, after the first ejecting step, moving the first nozzle and the second nozzle relatively to the stage in the first axial direction such that the first nozzle overlaps the second region and the second nozzle overlaps the first region when viewed in the second axial direction, and the nozzle switching step may be performed after the second moving step.

With the three-dimensional shaped object manufacturing method, when the first nozzle is switched to the second nozzle, it is possible to prevent the second nozzle from coming into contact with the shaped object formed on the stage.

In the three-dimensional shaped object manufacturing method according to the aspect, the ejecting step may include a raising step of raising the first nozzle and the second nozzle relatively to the stage in the second axial direction after the first ejecting step, and the nozzle switching step may be performed during the raising step.

With the three-dimensional shaped object manufacturing method, it is possible to reduce a manufacturing time for the three-dimensional shaped object.

In the three-dimensional shaped object manufacturing method according to the aspect, the ejecting step may include a raising step of raising the first nozzle and the second nozzle relatively to the stage in the second axial direction after the first ejecting step, and the nozzle switching step may be performed after the raising step.

With the three-dimensional shaped object manufacturing method, when the first nozzle is switched to the second nozzle, it is possible to prevent the second nozzle from coming into contact with the shaped object formed on the stage.

In the three-dimensional shaped object manufacturing method according to the aspect, the ejecting step may include: a raising step of raising the first nozzle and the second nozzle relatively to the stage in the second axial direction after the first ejecting step; and a third moving step of, after the raising step, moving the first nozzle and the second nozzle relatively to the stage in the first axial direction such that the first nozzle does not overlap the first region and the second region and the second nozzle does not overlap the first region and the second region when viewed in the second axial direction, and the first moving step may be performed after the third moving step.

With the three-dimensional shaped object manufacturing method, it is possible to reduce the likelihood that dust falls on the shaped object.

In the three-dimensional shaped object manufacturing method according to the aspect, in the third moving step, the first nozzle and the second nozzle may be moved relatively to the stage in the first axial direction such that the first nozzle and the second nozzle do not overlap the stage when viewed in the second axial direction.

With the three-dimensional shaped object manufacturing method, it is possible to reduce the likelihood that dust falls on the stage.

In the three-dimensional shaped object manufacturing method according to the aspect, in the first ejecting step, the plasticized material may be ejected toward a first region of the stage, in the nozzle switching step, after the first nozzle is raised in the second axial direction, the first nozzle and the second nozzle may be moved relatively to the stage in the first axial direction such that the second nozzle overlaps a second region different from the first region of the stage when viewed in the second axial direction, and thereafter the second nozzle may be lowered in the second axial direction, and, in the second ejecting step, the plasticized material may be ejected toward the second region.

With the three-dimensional shaped object manufacturing method, it is possible to reduce a manufacturing time for the three-dimensional shaped object.

In the three-dimensional shaped object manufacturing method according to the aspect, the second nozzle may overlap the first region when viewed in the second axial direction after the first ejecting step and before the nozzle switching step.

With the three-dimensional shaped object manufacturing method, even when the second nozzle overlaps the first region, it is possible to prevent the second nozzle from coming into contact with the shaped object formed on the stage.

What is claimed is:

1. A three-dimensional shaped object manufacturing method for manufacturing a three-dimensional shaped object by ejecting a plasticized material from a first nozzle and a second nozzle disposed side by side in a first axial direction toward a stage and stacking a shaping layer formed by the plasticized material on the stage, the three-dimensional shaped object manufacturing method comprising:
a plasticizing step of plasticizing a material to generate the plasticized material; and
an ejecting step of ejecting the plasticized material from the first nozzle and the second nozzle toward the stage while moving the first nozzle and the second nozzle relatively to the stage in the first axial direction, wherein
the ejecting step includes:
a first ejecting step of ejecting the plasticized material from the first nozzle;
a nozzle switching step of raising the first nozzle in a second axial direction perpendicular to the stage and lowering the second nozzle in the second axial direction after the first ejecting step; and
a second ejecting step of ejecting the plasticized material from the second nozzle after the nozzle switching step, and
the nozzle switching step is performed at a position where height in the second axial direction of a distal end of the first nozzle and height in the second axial direction of a distal end of the second nozzle are higher than height in the second axial direction of a shaped object including the shaping layer.

2. The three-dimensional shaped object manufacturing method according to claim 1, wherein
in the first ejecting step, the plasticized material is ejected toward a first region of the stage,
the ejecting step includes a first moving step of, after the nozzle switching step, moving the first nozzle and the second nozzle relatively to the stage in the first axial direction such that the second nozzle overlaps a second region different from the first region of the stage when viewed in the second axial direction, and
in the second ejecting step, the plasticized material is ejected toward the second region after the first moving step.

3. The three-dimensional shaped object manufacturing method according to claim 2, wherein
the ejecting step includes a second moving step of, after the first ejecting step, moving the first nozzle and the second nozzle relatively to the stage in the first axial direction such that the first nozzle overlaps the second region and the second nozzle overlaps the first region when viewed in the second axial direction, and
the nozzle switching step is performed after the second moving step.

4. The three-dimensional shaped object manufacturing method according to claim 1, wherein
the ejecting step includes a raising step of raising the first nozzle and the second nozzle relatively to the stage in the second axial direction after the first ejecting step, and
the nozzle switching step is performed during the raising step.

5. The three-dimensional shaped object manufacturing method according to claim 1, wherein
the ejecting step includes a raising step of raising the first nozzle and the second nozzle relatively to the stage in the second axial direction after the first ejecting step, and
the nozzle switching step is performed after the raising step.

6. The three-dimensional shaped object manufacturing method according to claim 2, wherein
the ejecting step includes:
a raising step of raising the first nozzle and the second nozzle relatively to the stage in the second axial direction after the first ejecting step; and
a third moving step of, after the raising step, moving the first nozzle and the second nozzle relatively to the stage in the first axial direction such that the first nozzle does not overlap the first region and the second region and the second nozzle does not overlap the first region and the second region when viewed in the second axial direction, and
the first moving step is performed after the third moving step.

7. The three-dimensional shaped object manufacturing method according to claim 6, wherein, in the third moving step, the first nozzle and the second nozzle are moved relatively to the stage in the first axial direction such that the first nozzle and the second nozzle do not overlap the stage when viewed in the second axial direction.

8. The three-dimensional shaped object manufacturing method according to claim 1, wherein
in the first ejecting step, the plasticized material is ejected toward a first region of the stage,
in the nozzle switching step, after the first nozzle is raised in the second axial direction, the first nozzle and the second nozzle are moved relatively to the stage in the first axial direction such that the second nozzle overlaps a second region different from the first region of the stage when viewed in the second axial direction, and thereafter the second nozzle is lowered in the second axial direction, and
in the second ejecting step, the plasticized material is ejected toward the second region.

9. The three-dimensional shaped object manufacturing method according to claim 2, wherein the second nozzle overlaps the first region when viewed in the second axial direction after the first ejecting step and before the nozzle switching step.
